(19) United States
(12) Patent Application Publication
(10) Pub. No.: US 2007/0232400 A1
(43) Pub. Date: Oct. 4, 2007

(54) Server, game data downloading method, and information storage medium

(75) Inventors: Kazuo Takahashi, Tokyo (JP); Haruki Suzaki, Yokohama-shi (JP)

Correspondence Address: OLIFF & BERRIDGE, PLC, P.O. BOX 19928, ALEXANDRIA, VA, 22320, US

(73) Assignee: NAMCO BANDAI Games Inc., Tokyo (JP)

(21) Appl. No.: 11/727,450

(22) Filed: Mar. 27, 2007

(30) Foreign Application Priority Data
Mar. 30, 2006 (JP) 2006-095965

(51) Int. Cl. A63F 13/00

(52) U.S. Cl. 463/42

(57) ABSTRACT

A game server selects pieces of character control data according to a distribution pattern indicated by a game terminal based on an experience level and a used character received from the game terminal. 100 pieces of selected character control data are combined to create package data, and the package data is downloaded to the game terminal.

Japanese Patent Application No. 2006-95965 filed on Mar. 30, 2006, is hereby incorporated by reference in its entirety.

### BACKGROUND OF THE INVENTION

The present invention relates to a server connected via a communication channel with a game device capable of executing a unit game which realizes various game processes using different pieces of control data and the like.

JP-A-2006-43439 discloses technology in which control data for controlling a character is downloaded from a server to enable a player to play a match with a character controlled by a CPU based on the downloaded control data (hereinafter called “control character”).

According to the technology disclosed in JP-A-2006-43439, only one piece of control data can be downloaded from the server at one time. Therefore, when a player desires to play a match with a number of control characters, the player must download pieces of play data one by one. This operation takes time.

A player generally determines the downloading target control data depending on the player's skill. For example, a beginner player may desire to play a match with a weak control character, and an advanced player may desire to play a match with a strong control character. A player may also desire to play a match with a control character which is weaker or stronger than the player. In view of the above situation, it is convenient if control data corresponding to the player's skill or satisfying the player's desire can be appropriately acquired.

### SUMMARY

According to one aspect of the invention, there is provided a server connected via a communication channel with a game device capable of executing a unit game which realizes various game processes using different pieces of control data, the server comprising:

a control data storage section which stores a number of pieces of control data while associating each piece of control data with an experience level;

a level reception section which receives the experience level from the game device;

a selection section which selects a number of pieces of control data downloaded to the game device from the pieces of control data stored in the control data storage section based on a standard experience level which is the experience level received by the level reception section; and

a downloading section which downloads the pieces of control data selected by the selection section to the game device.

### BRIEF DESCRIPTION OF THE SEVERAL VIEWS OF THE DRAWING

FIG. 1 is a schematic configuration view of a game system.

FIG. 2 is a view showing a data configuration example of a character control DB.

FIGS. 3A, 3B, and 3C are views showing examples of a distribution pattern.

FIG. 4 is a schematic external configuration view of a game terminal.

FIG. 5 is a block diagram showing a functional configuration of a game server.

FIG. 6 is a block diagram showing a functional configuration of a game terminal.

FIG. 7 is a view showing a data configuration example of play data.

FIG. 8 is a flowchart showing the flow of a data management process.

FIG. 9 is a flowchart showing the flow of a package generation process.

FIG. 10 is a flowchart showing the flow of a main process.

FIG. 11 is a flowchart showing the flow of a game process.

FIG. 12 is a flowchart showing the flow of a downloading process.

FIG. 13 is a view showing a hardware configuration example.

FIG. 14 is a view showing a data configuration example of ghost data according to a modification.

FIG. 15 is a view showing another data configuration example of ghost data according to a modification.

### DETAILED DESCRIPTION OF THE EMBODIMENT

According to the invention, a number of pieces of control data corresponding to the player's skill can be acquired without downloading the pieces of control data one by one.

According to one embodiment of the invention, there is provided a server connected via a communication channel with a game device capable of executing a unit game which realizes various game processes using different pieces of control data, the server comprising:

a control data storage section which stores a number of pieces of control data while associating each piece of control data with an experience level;

a level reception section which receives the experience level from the game device;

a selection section which selects a number of pieces of control data downloaded to the game device from the pieces of control data stored in the control data storage section based on a standard experience level which is the experience level received by the level reception section; and

a downloading section which downloads the pieces of control data selected by the selection section to the game device.

According to another embodiment of the invention, there is provided a game data downloading method for execution by a server connected via a communication channel with a game device capable of executing a unit game which realizes various game processes using different pieces of control data, the server including a control data storage section which stores a number of pieces of control data while associating each piece of control data with an experience level, the method comprising:

a level reception step of receiving the experience level from the game device;

a selection step of selecting a number of pieces of control data downloaded to the game device from the pieces of control data stored in the control data storage section based on a standard experience level which is the experience level received by the level reception section; and

a downloading step of collectively or continuously downloading the pieces of control data selected in the selection step to the game device.

According to the above configuration, the pieces of control data downloaded to the game device are selected from a number of stored pieces of control data based on the standard experience level which is the experience level received from the game device. The selected pieces of control data are downloaded to the game device.

Since a number of pieces of control data are selected and downloaded at one time, a number of pieces of control data can be acquired without downloading the pieces of control data one by one. Moreover, since the pieces of control data are selected based on the experience level received from the game device, the pieces of control data corresponding to the player's skill can be acquired.

The server according to this embodiment may comprising:

a downloading number reception section which receives the number of pieces of control data downloaded from the game device;

wherein the selection section selects the pieces of control data in the number received by the downloading number reception section.

According to this configuration, the number of pieces of control data downloaded is received from the game device, and the pieces of control data are selected in the received number.

The server according to this embodiment may comprising:

a downloaded data management section which manages the pieces of control data downloaded by the downloading section in units of the game device or a user of the game device as a requester; and

a requester information reception section which receives from the game device requester information which is identification information of the game device or a user name of the game device;

wherein the selection section selects the control data which has not been downloaded to the requester based on the requester information received by the requester information reception section and the control data which has been downloaded to the requester and is managed by the downloaded data management section.

According to this configuration, the downloaded control data is managed in units of the game device or the user of the game device as the requester. The server receives the requester information which is the identification information of the game device or the user name of the game device from the game device, and the control data which has not been downloaded to the requester is selected based on the received requester information and the control data which has been downloaded to the requester. This effectively prevents a situation in which the same piece of control data is repeatedly downloaded when downloading the control data a number of times.

The server according to this embodiment may comprising:

a downloading exclusion data reception section which receives an indication signal indicating a piece of control data excluded from a downloading target from the game device;

wherein the selection section selects the downloading target control data without selecting the piece of control data excluded from the downloading target which is indicated by the indication signal received by the download exclusion data reception section.

According to this configuration, the server receives the indication signal indicating the control data excluded from the downloading target, and selects the downloading target control data without selecting the control data excluded from the downloading target which is indicated by the received indication signal. This makes it possible to control the server so that the control data which is not requested by the player is not downloaded while achieving the above effects.

According to a further embodiment of the invention, there is provided a server connected via a communication channel with a game device capable of executing a unit game which realizes various game processes using different pieces of control data, the server comprising:

a control data storage section which stores a number of pieces of control data while associating each piece of control data with an experience level;

a selection section which executes a process of selecting a number of pieces of control data downloaded to the game device from the pieces of control data stored in the control data storage section based on a given standard experience level while setting each of the experience levels as the standard experience level;

a level reception section which receives the experience level from the game device; and

a downloading section which downloads the pieces of control data selected by the selection section when setting the experience level received by the level reception section as the standard experience level to the game device.

According to a further embodiment of the invention, there is provided a game data downloading method for execution by a server connected via a communication channel with a game device capable of executing a unit game which realizes various game processes using different pieces of control data, the server including a control data storage section which stores a number of pieces of control data while associating each piece of control data with an experience level, the method comprising:

a selection step of executing a process of selecting a number of pieces of control data downloaded to the game device from the pieces of control data stored in the control data storage section based on a given standard experience level for each case where each of the experience levels is set as the standard experience level;

a level reception step of receiving the experience level from the game device; and

a downloading step of collectively or continuously downloading to the game device the pieces of control data selected in the selection step when setting the experience level received by the level reception section as the standard experience level.

According to the above configuration, the process of selecting a number of pieces of control data downloaded to the game device from a number of stored pieces of control data based on a given standard experience level is executed while setting each experience level as the standard experience level, and the pieces of control data selected when setting the experience level received from the game device as the standard experience level are downloaded to the game device.

Therefore, since the combination of the pieces of control data downloaded to the game device has been determined in advance for all the experience levels, the processing load can be reduced in comparison with the case of determining the combination of the pieces of control data downloaded one by one in response to the request from the game device.

In the server according to this embodiment,

the unit game may be a game in which a player's character plays a match with a computer-controlled character which is computer-controlled based on the control data;

the game device may include a control data generation section which generates control data used as a control standard when controlling the player's character of the game device as the computer-controlled character;

the server may further include a control data reception section which receives the control data generated by the control data generation section of the game device from the game device; and

the control data storage section may store the control data received by the control data reception section.

According to this configuration, the control data is generated in the game device, and the control data received from the game device is stored in the control data storage section. Therefore, not only the fixed control data stored in advance, but also the control data reflecting the actual play of the player is acquired.

In the server according to this embodiment,

the selection section may select the pieces of control data with a neighborhood level including the same level as the standard experience level and a level near the standard experience level as the downloading target control data.

According to this configuration, the pieces of control data with the neighborhood level including the same level as the standard experience level and a level near the standard experience level are selected as the pieces of control data downloaded. Therefore, appropriate pieces of control data are acquired in a match game or the like even when the player desires to play a match with control characters with a level almost the same as the player's level.

In the server according to this embodiment,

the selection section may select the pieces of control data with a level other than the neighborhood level in addition to the pieces of control data with the neighborhood level in a number smaller than the number of pieces of control data with the neighborhood level.

According to this configuration, the pieces of control data with a level other than the neighborhood level are selected in addition to the appropriate pieces of control data with the neighborhood level in a number smaller than the number of pieces of control data with the neighborhood level. Therefore, appropriate pieces of control data are acquired in a match game or the like even when the player desires to play a match with control characters over a wide level range.

In the server according to this embodiment,

the selection section may select the pieces of control data with a level other than the neighborhood level so that the number of pieces of control data with a level other than the neighborhood level decreases as the level moves away from the neighborhood level.

According to this configuration, the pieces of control data with a level other than the neighborhood level are selected so that the number of pieces of control data with a level other than the neighborhood level decreases as the level moves away from the neighborhood level. This prevents a situation in which a large number of pieces of control data with an experience level significantly differing from the standard experience level are selected.

In the server according to this embodiment,

the selection section may select the pieces of control data with a level higher than the standard experience level in a number larger than the number of pieces of control data with a level lower than the standard experience level.

According to this configuration, the pieces of control data with a level higher than the standard experience level are selected in a number larger than the number of pieces of control data with a level lower than the standard experience level. Therefore, appropriate pieces of control data are acquired in a match game or the like even when the player desires to play a match with a large number of pieces of control characters with a level higher than the player's level rather than control characters with a level lower than the player's level.

According to a further embodiment of the invention, there is provided a game data downloading method for causing a computer which can be connected with the above server via a communication channel to download game data from the server, the method comprising:

a game execution step of executing a unit game which realizes various game processes using different pieces of control data based on the control data;

an experience level change step of changing an experience level of a player depending on results of the game executed in the game execution step; and

a downloading control step of transmitting a present experience level to the server to download the pieces of control data corresponding to the present experience level from the server.

According to this configuration, the unit game which realizes various game processes using different pieces of control data is executed, and the experience level of the player is changed depending on the game results. The present experience level is transmitted to the server, and the pieces of control data corresponding to the present experience level are downloaded from the server.

According to a further embodiment of the invention, there is provided a game data downloading method for causing a computer which can be connected with the above server via a communication channel to download game data from the server, the method comprising:

a downloading number determination step of determining the number of pieces of control data downloaded based on a free space in a storage section which stores the control data downloaded from the server;

a game execution step of executing a unit game which realizes various game processes using different pieces of control data based on the control data;

an experience level change step of changing an experience level of a player depending on results of the game executed in the game execution step; and

a downloading control step of transmitting a present experience level and the number determined in the downloading number determination step to the server to download the pieces of control data corresponding to the experience level from the server in the determined number.

According to this configuration, the number of pieces of control data downloaded is determined based on the free space in the storage section which stores the control data, and the unit game is executed based on the control data. The experience level of the player is changed depending on the game results, and the present experience level and the determined number are transmitted to the server so that the pieces of control data corresponding to the present experience level are downloaded from the server in the determined number. Therefore, appropriate pieces of control data corresponding to the experience level of the player are acquired, and a situation is effectively prevented in which the pieces of control data in a number exceeding the free space in the storage section are downloaded.

According to a further embodiment of the invention, there is provided a game data downloading method for causing a computer which can be connected with the above server via a communication channel to download game data from the server, the method comprising:

a game execution step of executing a unit game which realizes various game processes using different pieces of control data based on the control data;

an experience level change step of changing an experience level of a player depending on results of the game executed in the game execution step; and

a downloading control step of transmitting an indication signal which excludes the control data stored in a storage section which stores the control data downloaded from the server from a downloading target and a present experience level to download the pieces of control data which correspond to the present experience level and are not stored in the storage section from the server.

According to this configuration, the unit game is executed based on the control data, and the experience level of the player is changed depending on the game results. The indication signal which excludes the control data stored in the storage section from the downloading target and the present experience level are transmitted to the server, and the control data which corresponds to the present experience level and is not stored in the storage section is downloaded from the server. Therefore, appropriate pieces of control data corresponding to the experience level of the player are acquired, and a situation is prevented in which the same piece of control data is repeatedly downloaded when downloading the control data a number of times.

A further embodiment of the invention relates to a computer-readable information storage medium storing a program which causes a server or a computer to execute the above game data downloading method.

According to the invention, since a number of pieces of control data are selected and downloaded at one time, the pieces of control data can be acquired without downloading the pieces of control data one by one. Moreover, since the pieces of control data are selected based on the experience level received from the game device, the pieces of control data corresponding to the player's skill can be acquired.

The best mode for carrying out the invention is described below with reference to the drawings. The following embodiment illustrates the case where a player plays a fighting game as a unit game utilizing a game terminal 20 and play data generated and updated based on the game result is uploaded to a game server 10 or a number of pieces of character control data stored in the game server 10 are collectively downloaded as package data. Note that the embodiment to which the invention can be applied is not limited thereto.

As examples of the configuration of a game system utilizing a network, (A) a configuration in which a personal computer, a consumer game machine, a portable game machine, or the like is used as a game terminal and connected with a game server through a cable/wireless communication channel such as the Internet or a dedicated line, (B) a configuration in which a plurality of game terminals are connected through a communication channel without using a game server, (C) a configuration in which a plurality of game terminals are connected through a communication channel and one of the game terminals has a game server function, (D) a configuration in which a plurality of game terminals are physically connected to form one system (e.g. arcade game machine), and the like can be given. This embodiment is described below taking a game system having the configuration (A) as an example. In more detail, a game server is provided for a game service provider such as the manufacturer, and a consumer game machine is utilized as a game terminal.

### 1. System Configuration

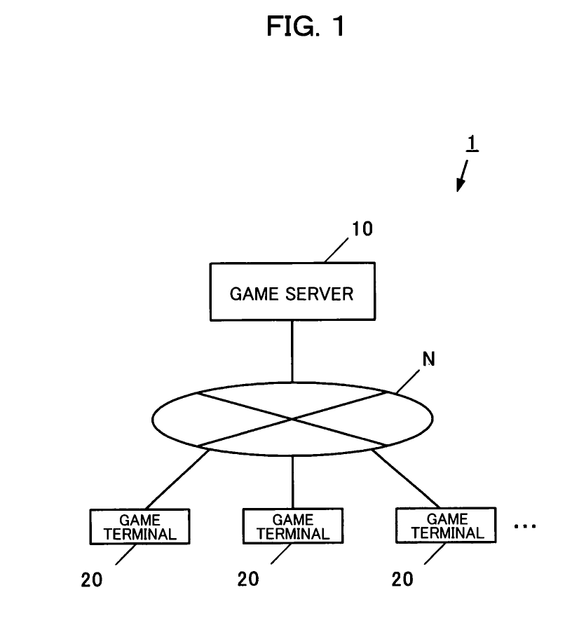

FIG. 1 is a view showing a schematic configuration of a game system 1 to which the invention is applied. The game system 1 includes a game server 10 and a plurality of game terminals 20. Each game terminal 20 is connected with the game server 10 through a communication channel N.

The game server 10 is implemented by a known server device, a known server system, or the like, and manages various types of data such as character control data 171 and play data 282 by appropriately executing a data management program 162.

In more detail, the game server 10 receives an access request signal from the game terminal 20, and, when the request is an uploading request of the play data 282, executes a character control data reception process of registering the uploaded play data 282 in a character control database (DB) 170 as the character control data 171. The uploaded character control data 171 is used to control a CPU character as a ghost character.

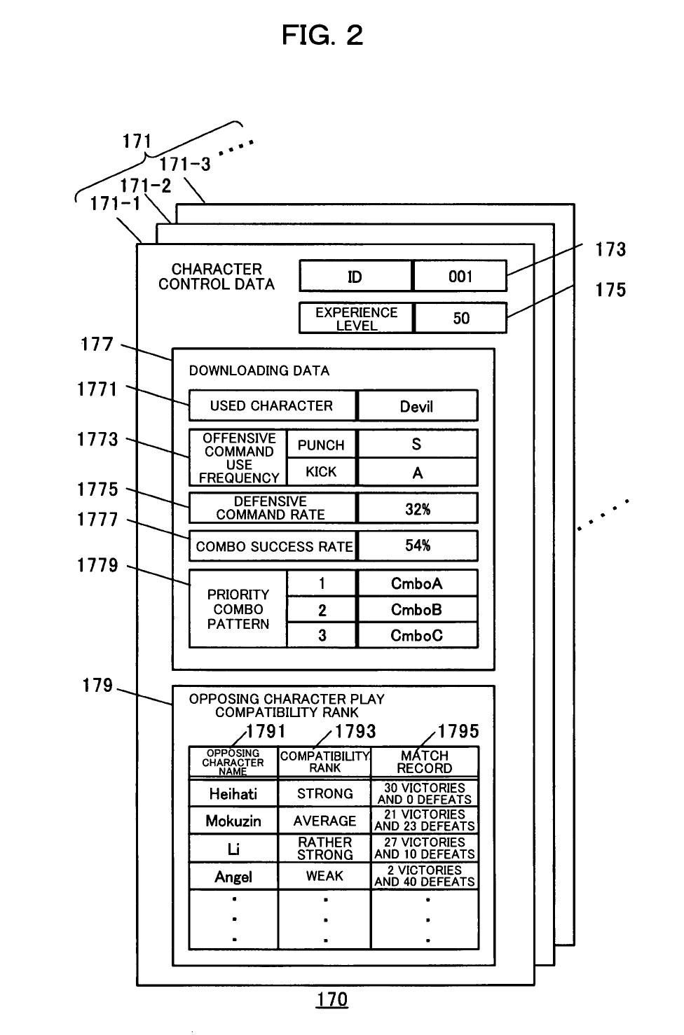

FIG. 2 is a view showing a data configuration example of the character control DB 170.

The character control DB 170 stores a number of pieces of character control data 171 (171-1, 171-2, 171-3, . . . ). Each piece of character control data 171 is associated with an ID 173, an experience level 175, downloading data 177, and opposing character play compatibility rank 179.

The ID 173 is a number for uniquely identifying the character control data 171. The experience level 175 is a level indicating the strength of the character. The downloading data 177 is data downloaded to the game terminal 20 as package data. In a match process executed in the game terminal 20, a control character is controlled by a CPU based on the downloading data 177. The opposing character play compatibility rank 179 is data which stores match compatibility with other characters.

A used character 1771, an offensive command use frequency 1773, a defensive command rate 1775, a combo success rate 1777, and a priority combo pattern 1779 are associated with one another as the downloading data 177.

A name for identifying a used character is set as the used character 1771. A rank based on the frequency of offensive movement is set as the offensive command use frequency 1773 in units of offensive movements such as a punch and a kick. The rank is classified as “SS”, “S”, “A”, “B”, or “C”. The rank “SS” indicates the highest frequency, and the rank “C” indicates the lowest frequency.

The use frequency (%) of a defensive command during game play is set as the defensive command rate 1775. The success rate (%) of a combo offensive movement during game play is set as the combo success rate 1777. Three combo offensive movements with a higher success rate among combo offensive movements performed during game play are set as the priority combo pattern 1779 in the order of the success rate.

An opposing character name 1791, a compatibility rank 1793, and a match record 1795 are associated with one another as the opposing character play compatibility rank 179.

The name of a character with which the player has played a match is set as the opposing character name 1791. The compatibility rank 1793 indicates compatibility with the character determined by the match record 1795. A rank “strong”, “rather strong”, “average”, “rather weak”, or “weak” is set as the compatibility rank 1793. The match record of matches with the opposing character is set as the match record 1795.

For example, the character control data 171-1 is data of which the ID 173 is “001” and the experience level 175 is “50”. The used character 1771 is “Devil”, the rank of the punch set as the offensive command use frequency 1773 is “S”, and the rank of the kick set as the offensive command use frequency 1773 is “A”. The defensive command rate 1775 is “32%”, and the combo success rate 1777 is “54%”. As indicated by the priority combo pattern 1779, a combo with the highest success rate is “CmboA”, a combo with the second highest success rate is “CmboB”, and a combo with the third highest success rate is “CmboC”.

The match record 1795 with a character “Heihati” is “30 victories and 0 defeats” (compatibility rank 1793: “strong”). On the other hand, the match record 1795 with a character “Angel” is “2 victories and 40 defeats” (compatibility rank 1793: “weak”).

Specifically, the player who uploaded the character control data 171-1 was stronger than the character “Heihati”, but was weaker than the character “Angel”. Therefore, when a CPU character is controlled based on the character control data 171-1, the CPU character is likely to be stronger than the character “Heihati”, but weaker than the character “Angel”.

The player's play data 282 received from the game terminal 20 is stored in the character control DB 170 as the character control data 171.

When the request indicated by the access request signal is a package data downloading request, the game server 10 receives an experience level 2831 and a used character 2821 among the data included in the play data 282 from the game terminal 20. The game server 10 executes a package generation process of generating package data by combining a number of pieces of character control data 171 based on the received experience level 2831 and used character 2821, and downloads the generated package data to the game terminal 20 by executing a package downloading process.

The package data generation principle is as follows.

The game server 10 generates the package data based on one of predetermined distribution patterns indicated by a distribution pattern indication signal transmitted from the game terminal 20. Specifically, the player who uses the game terminal 20 can direct the game server 10 to generate the package data based on the desired distribution pattern.

The distribution pattern is a pattern indicating the distribution of the relationship between the experience level and the number of pieces of character control data 171 selected. Several levels around the experience level (standard level) received from the game terminal 20 are determined to be downloading target levels, and the number of pieces of character control data 171 selected is specified for each downloading target level.

Specifically, the game server 10 uses the experience level 2831 received from the game terminal 20 as the standard level, and determines the downloading target levels according to the distribution pattern indicated by the player.

The game server 10 extracts the pieces of character control data 171 of the same experience level 175 as each downloading target level from the character control DB 170. The game server 10 selects the pieces of character control data 171 in a number set for each experience level in the distribution pattern indicated by the player from the pieces of character control data 171 extracted corresponding to the experience level.

The character control data 171 is selected according to the following method. Specifically, the game server 10 checks the compatibility rank 1793 with the used character 2821 received from the game terminal 20 referring to the opposing character play compatibility rank 179 included in each piece of extracted character control data 171. The game server 10 selects the pieces of character control data 171 in a specified number so that the character control data 171 of which the compatibility with the used character 2821 is “strong” is selected with a probability of “ 1/10”, the character control data 171 of which the compatibility with the used character 2821 is “rather strong” is selected with a probability of “ 2/10”, the character control data 171 of which the compatibility with the used character 2821 is “average” is selected with a probability of “ 4/10”, the character control data 171 of which the compatibility with the used character 2821 is “rather weak” is selected with a probability of “ 2/10”, and the character control data 171 of which the compatibility with the used character 2821 is “weak” is selected with a probability of “ 1/10”. This operation is performed for each experience level in the indicated distribution pattern.

The game server 10 combines the pieces of downloading data 177 included in all pieces of selected character control data 171 via compression or the like to create one piece of package data.

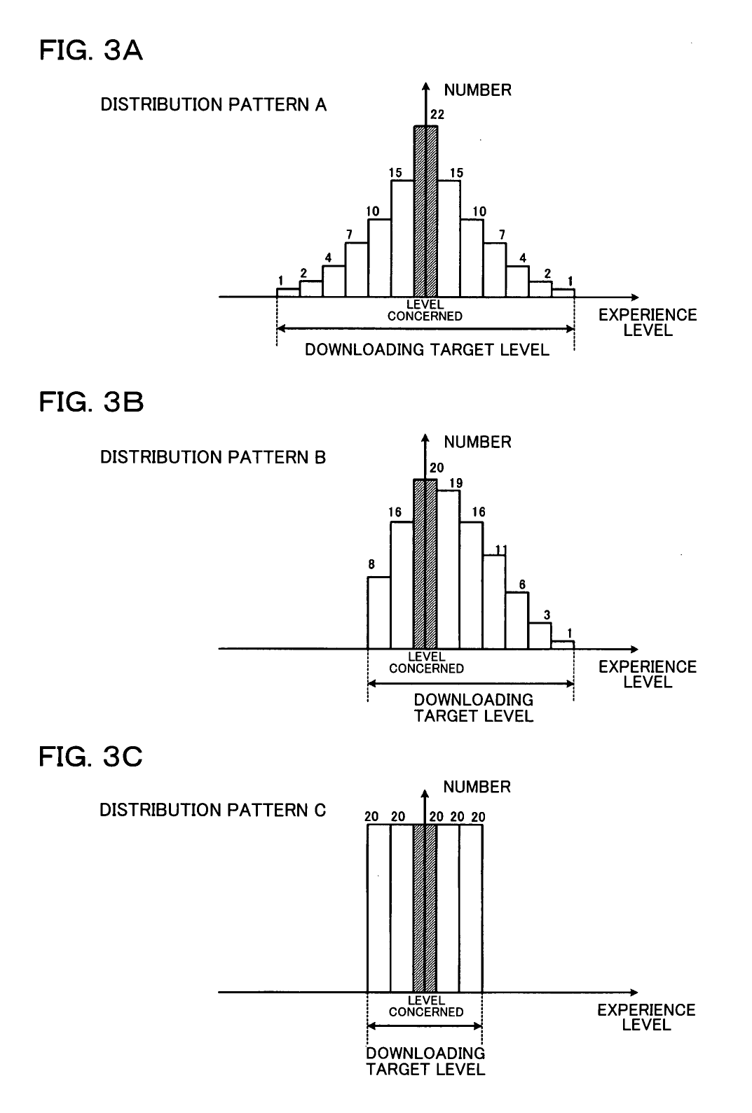

FIGS. 3A, 3B, and 3C are views showing examples of the distribution pattern. In each distribution pattern, the horizontal axis indicates the experience level, and the vertical axis indicates the number of pieces of character control data selected. In each distribution pattern, the sum of the numbers of pieces of character control data selected specified for the downloading target levels is “100” so that 100 pieces of character control data 171 are selected and packaged in total.

A distribution pattern A shown in FIG. 3A is a Gaussian function type distribution (Gaussian distribution) in which the number of pieces of character control data selected is symmetrically (in height) and gradually reduced as the experience level moves away from the standard level. In more detail, the largest number “22” is specified for the standard level, and the number is reduced in the order of “15”, “10”, “7”, “4”, “2”, and “1” in level units. The distribution pattern A is a distribution suitable for the case where the player desires to play a match with control characters over a wide level range collected in a well-balanced manner.

A distribution pattern B shown in FIG. 3B is the same as the distribution pattern A in that the number of pieces of character control data selected is gradually reduced as the experience level moves away from the standard level, but differs from the distribution pattern A in that the sum of the numbers of pieces of character control data selected specified for the experience levels higher than the standard level is larger than the sum of the numbers of pieces of character control data selected specified for the experience levels lower than the standard level. In more detail, the largest number “20” is specified for the standard level, the number of pieces of character control data selected is reduced for the experience levels lower than the standard level in the order of “16” and “8” as the level becomes lower, and the number of pieces of character control data selected is reduced for the experience levels higher than the standard level in the order of “19”, “16”, “11”, “6”, “3”, and “1” as the level becomes higher. The distribution pattern B is a distribution suitable for the case where the player desires to play a match with a number of control characters with a level higher than the player's level rather than control characters with a level lower than the player's level.

A distribution pattern C shown in FIG. 3C is a distribution in which the number of pieces of character control data selected specified for the standard level is the same as the numbers of pieces of character control data selected specified for the experience levels around the standard level. In more detail, the number of pieces of character control data selected specified for the standard level is “20”, the number of pieces of character control data selected specified for the experience levels adjacent to the standard level is “20”, and the number of pieces of character control data selected specified for the next adjacent experience levels is also “20”. The distribution pattern C is a distribution suitable for the case where the player desires to play a match with uniformly collected control characters with a level almost the same as the player's level.

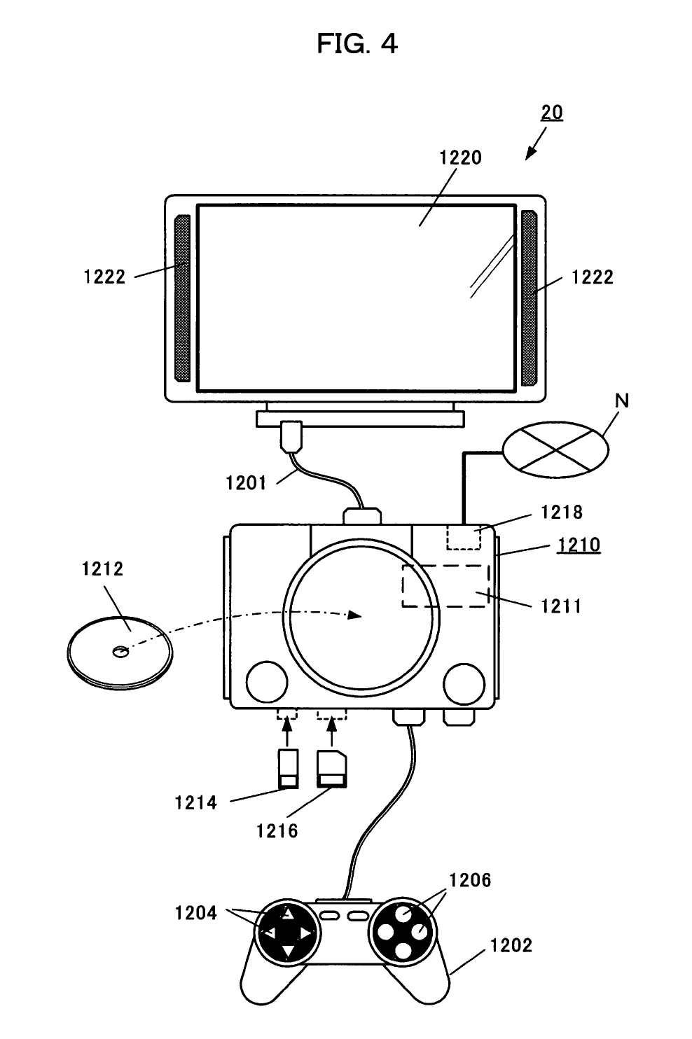

The game terminal 20 is a game device for a player to play a fighting game. FIG. 4 shows a schematic external configuration of the game terminal 20. The game terminal 20 is a consumer game machine, and includes a game controller 1202, a main device 1210, and a display 1220 including a speaker 1222. The game controller 1202 is connected with the main device 1210, and the display 1220 is connected with the main device 1210 through a cable 1201 through which an image signal, a sound signal, and the like can be transferred.

The game controller 1202 includes a direction key 1204 and button switches 1206 which allow a player to input a game operation and a screen display position, and outputs an operation input signal to the main device 1210.

The main device 1210 includes a control unit 1211 provided with a CPU and an IC memory and an information storage medium reading device, and calculates various game processes based on a program and data read from a CD-ROM 1212 or the like and an operation signal from the game controller 1202 to generate an image signal of a game screen and a sound signal of a game sound.

The main device 1210 generates an image of a virtual three-dimensional space viewed from a given virtual camera. The main device 1210 outputs the image signal and the sound signal to the display 1220, and causes the display 1220 to display a game screen and the speaker 1222 to output game sound. The player enjoys the game by operating the game controller 1202 while watching the game screen displayed on the display 1220.

A program, data, and the like necessary for the main device 1210 to execute the game process are stored in the CD-ROM 1212, an IC memory 1214, and a memory card 1216 which are information storage media removable from the main device 1210, for example. Or, the main device 1210 connects with the communication channel N through a communication device 1218 provided in the main device 1210, and downloads the necessary program, data, and the like from an external device (e.g. game server 10). The term “communication channel” used herein means a channel through which data can be exchanged. Specifically, the communication channel N includes a communication network such as a LAN using a private line (private cable) for direct connection, Ethernet (registered trademark), and the like, a telecommunication network, a cable network, and the Internet. The communication method may be a cable communication method or a wireless communication method.

The game terminal 20 executes the game process, selects the character control data 171 from a character control data group stored in the CD-ROM 1212 or package data downloaded to the memory card 1216, and executes a match process of causing a character to be controlled by the CPU based on the selected character control data 171 and play a match with a character operated by the player (hereinafter called “player's character”). The game terminal 20 generates and updates the play data 282 stored in the memory card 1216 based on the results of the match process.

The game terminal 20 executes a downloading process of transmitting the access request signal to the game server 10 to download the package data from the game server 10, and executes an uploading process of uploading the play data 282 stored in the memory card 1216 to the game server 10.

### 2. Functional Configuration

The functional configurations of the game server 10 and the game terminal 20 according to this embodiment are described below. The functional configuration of the game server 10 is as follows.

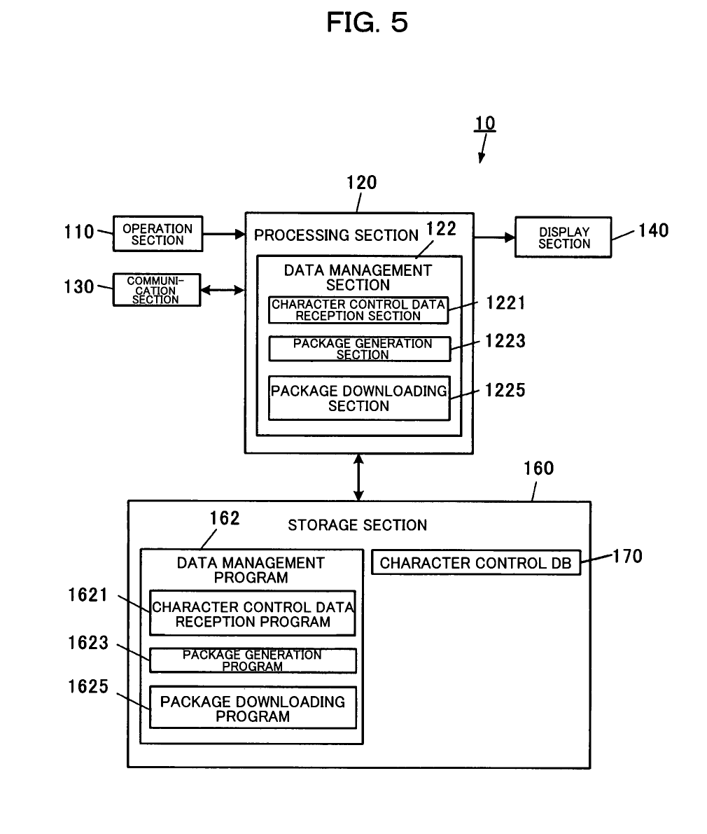

FIG. 5 is a block diagram showing the functional configuration of the game server 10. The game server 10 is a computer system including an operation section 110, a processing section 120, a communication section 130, a display section 140, and a storage section 160.

The operation section 110 receives operation instructions from the administrator of the game server 10 or the like, and outputs an operation signal corresponding to the operation to the processing section 120. The function of the operation section 110 is implemented by a button, an operation stick, a dial, a mouse, a keyboard, various sensors, and the like.

The processing section 120 controls the entire game server 10 and manages various types of data such as the character control data 171 and the play data 282. The function of the processing section 120 is implemented by a calculation device such as a CPU (CISC or RISC) or an ASIC (e.g. gate array) and its control program, for example.

In this embodiment, the processing section 120 includes a data management section 122 as the main functional section. The data management section 122 includes a character control data reception section 1221, a package generation section 1223, and a package downloading section 1225.

The data management section 122 executes a data management process according to a data management program 162. The character control data reception section 1221 stores the play data 282 uploaded from the game terminal 20 in the character control DB 170 as the character control data 171 according to a character control data reception program 1621.

The package generation section 1223 combines the pieces of downloading data 177 included in the pieces of character control data 171 selected from the character control DB 170 according to a package generation program 1623 to generate package data.

The package downloading section 1225 downloads the package data generated by the package generation section 1223 to the game terminal 20.

The communication section 130 connects with a specific communication channel (e.g. wireless communication channel or LAN), and performs data communication with an external device (e.g. game terminal 20). The function of the communication section 130 is implemented by a wireless communication module such as a wireless LAN, a modem, a TA, a jack for a communication cable, a control circuit, and the like.

The display section 140 is a means for displaying characters and an image. The display section 140 displays a screen based on a display signal output from the processing section 120. The function of the display section 140 is implemented by hardware such as a CRT, an LCD, an ELD, a PDP, or an HMD.

The storage section 160 stores a system program for implementing each function for causing the processing section 120 to integrally control the game server 10, a program and data necessary for causing the processing section 120 to execute various processes, and the like. The storage section 130 is used as a work area for the processing section 120, and temporarily stores the results of calculations executed by the processing section 120 according to various programs, data input from the operation section 110, and the like. The function of the storage section 130 is implemented by various IC memories, a hard disk, a CD-ROM, a DVD, an MO, a RAM, a VRAM, or the like.

In this embodiment, the storage section 160 includes the data management program 162 for causing the processing section 120 to function as the data management section 122, and the character control DB 170. A data configuration example of the character control DB 170 is the same as shown in FIG. 2.

The data management program 162 includes as subroutines the character control data reception program 1621 for causing the data management section 122 to function as the character control data reception section 1221, the package generation program 1623 for causing the data management section 122 to function as the package generation section 1223, and a package downloading program 1625 for causing the data management section 122 to function as the package downloading section 1225.

The functional configuration of the game terminal 20 is described below.

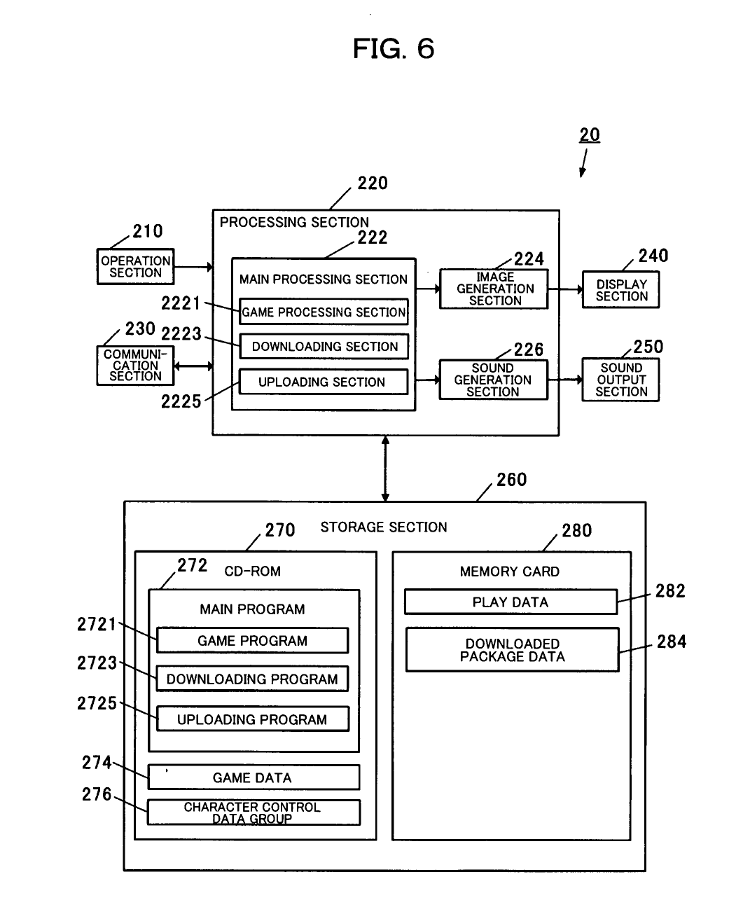

FIG. 6 is a block diagram showing the functional configuration of the game terminal 20. The game terminal 20 includes an operation section 210, a processing section 220, a communication section 230, a display section 240, a sound output section 250, and a storage section 260.

The operation section 210 receives operation instructions from the player, and outputs an operation signal corresponding to the operation to the processing section 220. The function of the operation section 210 is implemented by an operation device including a button, an operation stick, a dial, a mouse, a keyboard, various sensors, and the like. The operation section 210 corresponds to the controller 1202 shown in FIG. 4.

The processing section 220 controls the entire game terminal 20 and executes various calculations for proceeding with a game and generating an image. The function of the processing section 220 is implemented by a calculation device such as a CPU (CISC or RISC) or an ASIC (e.g. gate array) and its control program, for example. The processing section 220 corresponds to the control unit 1211 shown in FIG. 4.

In this embodiment, the processing section 200 includes a main processing section 222 which integrally controls the game terminal 20 according to a main program 272, an image generation section 224 which generates an image of a virtual three-dimensional space (game space) viewed from a given view point such as a virtual camera and generates an image signal for displaying a game screen based on various types of data calculated by a game processing section 2221, and a sound generation section 226 which generates game sound such as effect sound and background music (BGM) and generates a sound signal for outputting the game sound. The main processing section 222 includes the game processing section 2221, a downloading section 2223, and an uploading section 2225.

The game processing section 2221 executes a game process according to a game program 2721, selects the pieces of character control data 171 from a character control data group 276 stored in a CD-ROM 270 and downloaded package data 284 stored in a memory card 280, and executes a match process of causing a character to be controlled by the CPU based on the selected character control data 171 and play a match with a player's character.

The CPU character is controlled based on the character control data 171 using a known ghost character control technology. Therefore, detailed description thereof is omitted. The game processing section 2221 generates and updates the play data 282 stored in the memory card 280 based on the results of the match process.

The downloading section 2223 transmits the access request signal to the game server 10 to download the package data from the game server 10. The uploading section 2225 transmits the access request signal to the game server 10, and uploads the play data 282 stored in the memory card 280 to the game server 10.

The image generation section 224 is implemented by a calculation device such as a CPU or a DSP and its control program, a drawing frame IC memory such as a frame buffer, and the like. The image generation section 224 generates a game image (3D CG image) for displaying a game screen by executing geometric transformation, shading, and the like based on the calculation results from the game processing section 2221, and outputs an image signal of the generated image to the display section 240.

The display section 240 displays a game screen based on the image signal from the image generation section 224 while redrawing the screen in one frame every 1/60 second, for example. The function of the display section 240 is implemented by hardware such as a CRT, an LCD, an ELD, a PDP, or an HMD. The display section 240 corresponds to the display 1220 shown in FIG. 4.

The sound generation section 226 is implemented by a calculation device such as a CPU or a DSP and its control program. The sound generation section 226 generates game sound such as effect sound and BGM used during a game, and outputs a sound signal of the generated game sound to the sound output section 250. The sound output section 250 outputs game sound such as BGM and effect sound based on the sound signal from the sound generation section 226. The function of the sound output section 250 is implemented by a speaker or the like. The sound output section 250 corresponds to the speaker 1222 shown in FIG. 4.

The communication section 230 connects with a specific communication channel (e.g. wireless communication channel or LAN) and performs data communication with an external device (e.g. game terminal 20). The function of the communication section 230 is implemented by a wireless communication module such as a wireless LAN, a modem, a TA, a jack for a communication cable, a control circuit, and the like. The communication section 230 corresponds to the communication device 1218 shown in FIG. 4.

The storage section 260 includes the CD-ROM 270 and the memory card 280, and stores a system program for implementing each function for causing the processing section 220 to integrally control the game terminal 20, a program and data necessary for causing the processing section 220 to execute a game, and the like. The storage section 260 is used as a work area for the processing section 220, and temporarily stores the results of calculations executed by the processing section 220 according to various programs, data input from the operation section 210, and the like. The function of the storage section 260 is implemented by various IC memories, a hard disk, a CD-ROM, a DVD, an MO, a RAM, a VRAM, or the like. The CD-ROM 270 corresponds to the CD-ROM 1212 shown in FIG. 4, and the memory card 280 corresponds to the memory card 1216 shown in FIG. 4.

In this embodiment, the CD-ROM 270 stores the main program 272 for causing the processing section 220 to function as the main processing section 222, game data 274, and the character control data group 276.

The main program 272 includes as subroutines the game program 2721 for causing the main processing section 222 to function as the game processing section 2221, a downloading program 2723 for causing the main processing section 222 to function as the downloading section 2223, and an uploading program 2725 for causing the main processing section 222 to function as the uploading section 2225.

The game data 274 is data utilized in the game process, and includes character model data, stage data, and the like. The character control data group 276 is data in which a number of pieces of character control data 171 are stored.

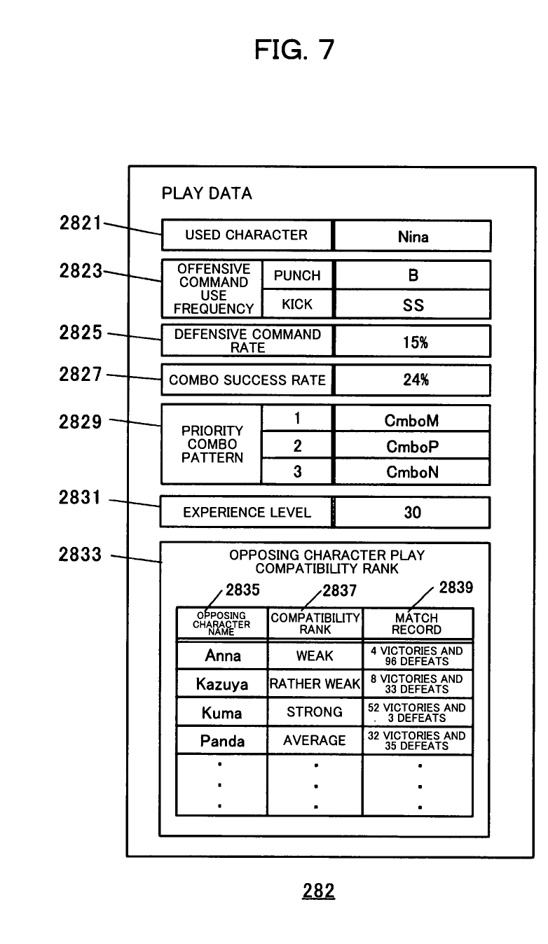

The memory card 280 stores the play data 282 and the downloaded package data 284. The play data 282 is data which is generated and updated in the game process based on the results of the match process. FIG. 7 shows a data configuration example of the play data 282.

A used character 2821, an offensive command use frequency 2823, a defensive command rate 2825, a combo success rate 2827, a priority combo pattern 2829, an experience level 2831, and an opposing character play compatibility rank 2833 are stored as the play data 282. The above data respectively corresponds to the data of the same name included in the control data 171 shown in FIG. 2.

In the play data 282 shown in FIG. 7, the used character 2821 is “Nina”, the rank of the punch of the offensive command use frequency 2823 is “B”, and the rank of the kick of the offensive command use frequency 2823 is “SS”. The defensive command rate 2825 is “15%”, and the combo success rate 2827 is “24%”. As indicated by the priority combo pattern 2829, a combo with the highest success rate is “CmboM”, a combo with the second highest success rate is “CmboP”, and a combo with the third highest success rate is “CmboN”. The experience level 2831 is “30”.

The match record 2839 with a character “Anna” is “4 victories and 96 defeats” (compatibility rank 2837: “weak”). On the other hand, the match record 2839 with a character “Panda” is “32 victories and 35 defeats” (compatibility rank 2837: “average”). Specifically, the player of this play data 282 was weaker than the character “Anna”, but was almost even with the character “Panda”.

The downloaded package data 284 is package data downloaded from the game server 10 by the downloading section 2223.

### 3. Process Flow

The process flow is described below.

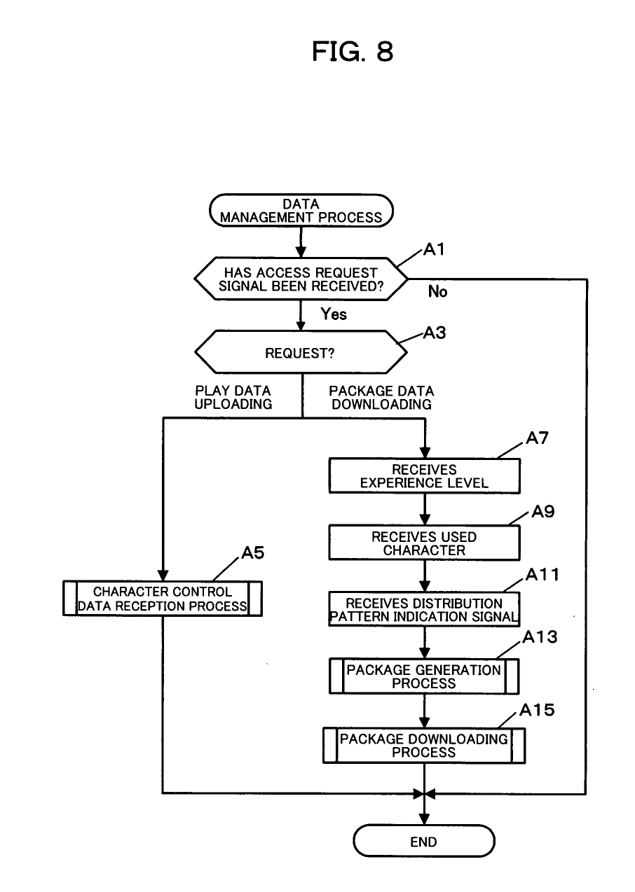

The process of the game server 10 is described below. FIG. 8 is a flowchart showing the flow of the data management process executed by the game server 10.

The data management section 122 determines whether or not the game server 10 has received the access request signal from the game terminal 20 (step A1). When the data management section 122 has determined that the game server 10 has not received the access request signal (step A1; No), the data management section 122 finishes the data management process. When the data management section 122 has determined that the game server 10 has received the access request signal (step A1; Yes), the data management section 122 determines the request (step A3).

When the data management section 122 has determined that the request is an uploading request of the play data 282 in the step A3 (step A3; play data uploading), the character control data reception section 1221 executes the character control data reception process (step A5). In more detail, the character control data reception section 1221 stores the play data 282 uploaded from the game terminal 20 in the character control DB 170 as the character control data 171. When the character control data reception process has been completed, the data management section 122 finishes the data management process.

When the data management section 122 has determined that the request is a downloading request of the play data 282 in the step A3 (step A3; play data downloading), the data management section 122 receives the experience level 2831 and the used character 2821 included in the play data 282 from the game terminal 20 (steps A7 and A9).

The data management section 122 receives the distribution pattern indication signal from the game terminal 20 (step A11). The package generation section 1223 executes the package generation process (step A13).

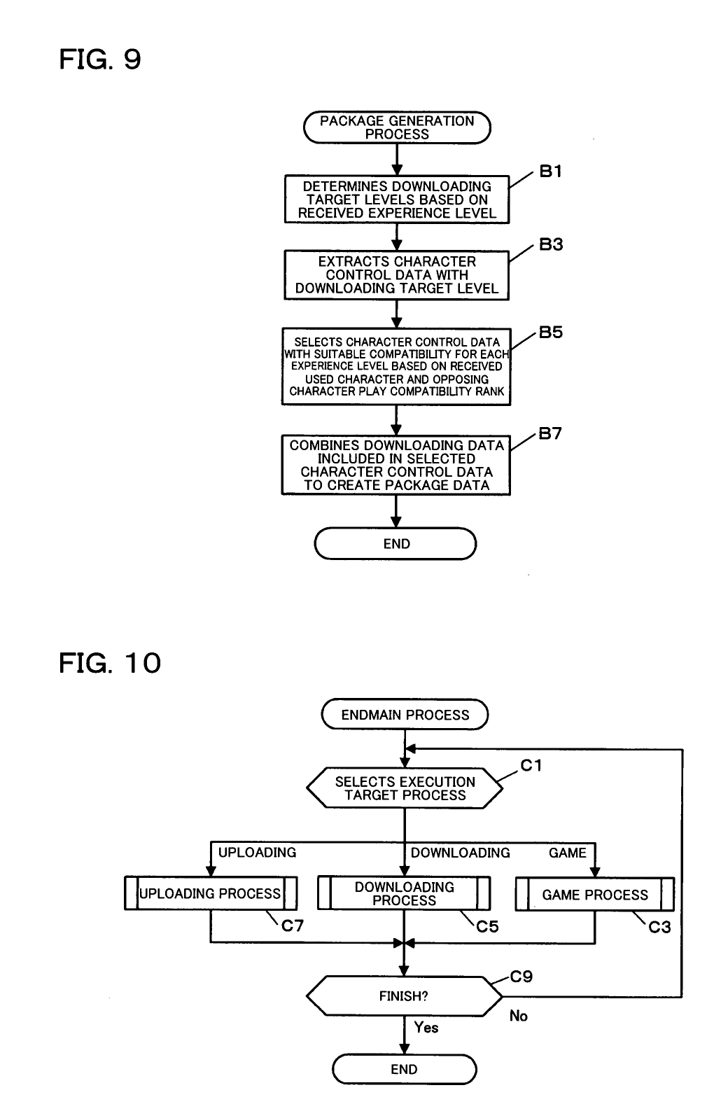

FIG. 9 is a flowchart showing the flow of the package generation process.

The package generation section 1223 determines the downloading target levels based on the experience level 2831 received in the step A7 (step B1). In more detail, the package generation section 1223 uses the received experience level 2831 as the standard level, and determines the downloading target levels according to one of the distribution patterns shown in FIG. 3A to 3C indicated by the distribution pattern indication signal received in the step A11.

The package generation section 1223 extracts the pieces of character control data 171 of the experience level 175 corresponding to each of the determined downloading target levels from the character control DB 170 (step B3).

The package generation section 1223 selects the pieces of character control data 171 from the extracted pieces of character control data 171 in a number specified for each experience level 175 in the indicated distribution pattern for each downloading target level based on the received used character 2821 and the opposing character play compatibility rank 179 included in the character control data 171 (step B5).

In more detail, the package generation section 1223 checks the compatibility rank 1793 with the received used character 2821 referring to the opposing character play compatibility rank 179 included in the extracted character control data 171. The package generation section 1223 selects the pieces of character control data 171 so that the character control data 171 of which the compatibility with the used character 2821 is “strong”is selected with a probability of “ 1/10”, the character control data 171 of which the compatibility with the used character 2821 is “rather strong” is selected with a probability of “ 2/10”, the character control data 171 of which the compatibility with the used character 2821 is “average” is selected with a probability of “ 4/10”, the character control data 171 of which the compatibility with the used character 2821 is “rather weak” is selected with a probability of “ 2/10”, and the character control data 171 of which the compatibility with the used character 2821 is “weak” is selected with a probability of “ 1/10”. The package generation section 1223 executes the above step for each experience level included in the indicated distribution pattern.

The package generation section 1223 combines the pieces of downloading data 177 included in the pieces of character control data 171 selected in the step B5 to create package data (step B7), and finishes the package generation process.

In the data management process shown in FIG. 8, when the package generation process has been completed, the package downloading section 1225 executes the package downloading process (step A15). In more detail, the package downloading section 1225 downloads the package data generated by the package generation process to the game terminal 20. When the package downloading process has been completed, the data management section 122 finishes the data management process.

The process of the game terminal 20 is described below. FIG. 10 is a flowchart showing the flow of the main process executed by the game terminal 20.

The main processing section 222 selects the execution target process according to an operation input from the player (step C1). When the selected process is the game process (step C1; game), the game processing section 2221 executes the game process (step C3).

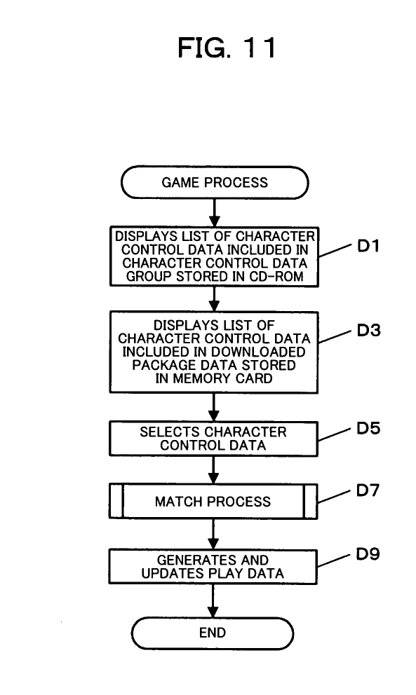

FIG. 11 is a flowchart showing the flow of the game process.

The game processing section 2221 causes the display section 240 to display a list of the pieces of character control data 171 included in the character control data group 276 stored in the CD-ROM 270 (step D1). The game processing section 2221 then causes the display section 240 to display a list of the pieces of character control data 171 included in the downloaded package data 284 stored in the memory card 280 (step D3).

The game processing section 2221 selects one piece of character control data 171 according to an operation input from the player (step D5). The game processing section 2221 creates a game space based on the game data 274, and executes the match process of causing the CPU to control a character based on the character control data 171 selected in the step D5 and controlling the player's character according to an operation input from the player to cause the characters to play a match (step D7).

The game processing section 2221 generates and updates the play data 282 stored in the memory card 280 based on the results of the match process (step D9), and finishes the game process. In more detail, the game processing section 2221 updates the offensive command use frequency 2823, the defensive command rate 2825, the combo success rate 2827, and the priority combo pattern 2829 based on the operation of the player in the match process.

When a condition for increasing or decreasing the experience level 2831 has been satisfied, the game processing section 2221 updates the experience level 2831. As an example of the condition for increasing the experience level 2831, a condition can be given in which the total number of victories becomes equal to or greater than a specific value. As an example of the condition for decreasing the experience level 2831, a condition can be given in which the total number of defeats becomes equal to or greater than a specific value.

The game processing section 2221 updates the match record 2839 of an opposing character name 2835 corresponding to the character with which the player has played a match based on the victory or defeat. When a condition for changing the compatibility rank 2837 has been satisfied as a result of updating the match record 2839, the game processing section 2221 changes the compatibility rank 2837. As an example of the condition for shifting the compatibility rank 2837 toward “strong”, a condition can be given in which the winning percentage becomes equal to or greater than a specific value. As an example of the condition for shifting the compatibility rank 2837 toward “weak”, a condition can be given in which the winning percentage becomes less than a specific value.

In the main processing shown in FIG. 10, when the process selected in the step C1 is a downloading process (step C1; downloading), the downloading section 2223 executes the downloading process (step C5).

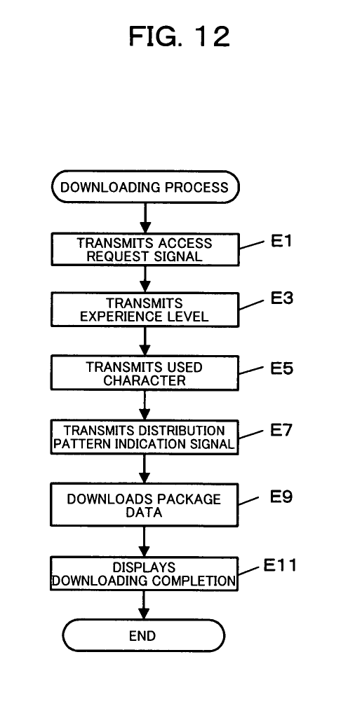

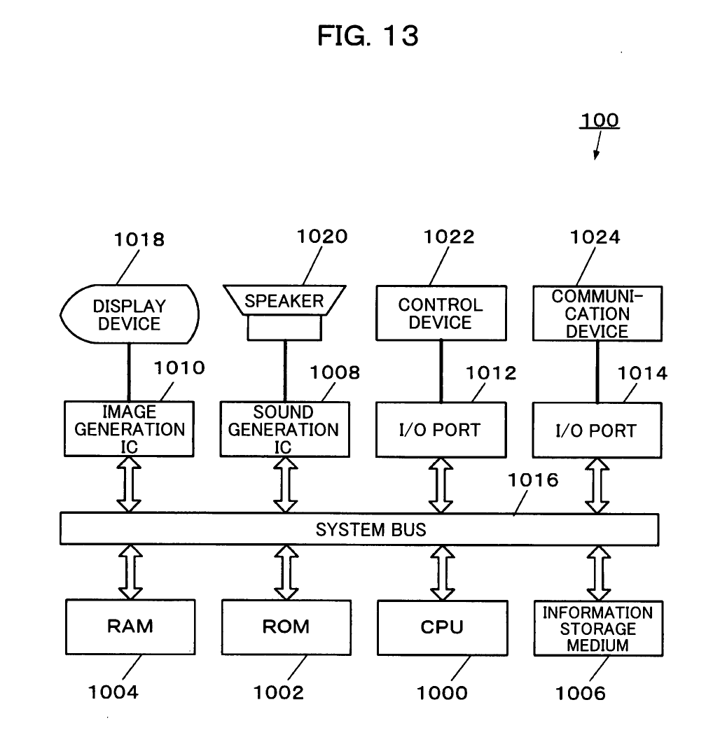

FIG. 12 is a flowchart showing the flow of the downloading process.

The downloading section 2223 transmits the access request signal to the game server 10 (step E1). The downloading section 2223 transmits the experience level 2831 in the play data 282 stored in the memory card 280 to the game server 10, and transmits the used character 2821 to the game server 10 (steps E3 and E5).

The downloading section 2223 transmits the distribution pattern indication signal to the game server 10 according to an operation input from the player (step E7). The downloading section 2223 downloads the package data from the game server 10 (step E9), stores the downloaded package data in the memory card 280 as the downloaded package data 284, causes the display section 240 to display a downloading completion message (step E11), and finishes the downloading process.

In the main processing shown in FIG. 10, when the process selected in the step C1 is a uploading process (step C1; uploading), the uploading section 2225 executes the uploading process (step C7). In more detail, the uploading section 2225 transmits the access request signal to the game server 10, and uploads the play data 282 stored in the memory card 280 to the game server 10.

When the process in one of the steps C3 to C7 has been completed, the main processing section 222 determines whether or not to finish the process according to an operation input from the player (step C9). When the main processing section 222 has determined that the process is not finished (step C9: No), the main processing section 222 returns to the step C1. When the main processing section 222 has determined that the process is finished (step C9: Yes), the main processing section 222 finishes the main process.

### 4. Hardware Configuration

An example of a hardware configuration for implementing the game server 10 and the game terminal 20 according to this embodiment is described below with reference to FIG. 13. An electronic instrument 100 shown in FIG. 13 includes a CPU 1000, a ROM 1002, a RAM 1004, an information storage medium 1006, a sound generation IC 1008, an image generation IC 1010, and I/O ports 1012 and 1014. These sections are connected through a system bus 1016 so that data can be exchanged (input and output).

The CPU 1000 controls the entire instrument and processes data according to a program stored in the information storage medium 1006, a system program stored in the ROM 1002, an operation input signal input from a control device 1022, and the like. The CPU 1000 corresponds to the processing section 120 shown in FIG. 5 and the processing section 220 shown in FIG. 6.

The RAM 1004 is a storage section used as a work area for the CPU 1000 and the like, and stores a given content in the information storage medium 1006 and the ROM 1002, the calculation results of the CPU 1000, and the like. The RAM 1004 corresponds to part of the storage section 160 shown in FIG. 5 and the storage section 260 shown in FIG. 6.

The information storage medium 1006 mainly stores a program, image data, sound data, play data, and the like. The information storage medium 1006 corresponds to part of the storage section 160 shown in FIG. 5 and the storage section 260 shown in FIG. 6. When this embodiment is implemented by a computer system, a CD-ROM, a DVD, a hard disk, or the like as an information storage medium which stores various programs and data is used as the information storage medium 1006.

Sound and an image can be suitably output using the image generation IC 1010 and the sound generation IC 1008 provided in the instrument.

The image generation IC 1010 is an integrated circuit which generates pixel information according to instructions from the CPU 1000 based on information transmitted from the ROM 1002, the RAM 1004, the information storage medium 1006, and the like. A display signal generated by the mage generation IC 1010 is output to a display device 1018. The display device 1018 is implemented by a CRT, an LCD, an ELD, a PDP, an HMD, or the like. The display device 1018 corresponds to the display section 140 shown in FIG. 5 and the display section 240 shown in FIG. 6.

The sound generation IC 1008 is an integrated circuit which generates a sound signal corresponding to the information stored in the information storage medium 1006 and the ROM 1002 and sound data stored in the RAM 1004 according to instructions from the CPU 1000. The sound signal generated by the sound generation IC 1008 is output from a speaker 1020. The speaker 1020 corresponds to the sound output section 250 shown in FIG. 6.

The control device 1022 is a device for inputting various operations. The function of the control device 1022 is implemented by hardware such as a keyboard, a mouse, and a touch panel. The control device 1022 corresponds to the operation section 110 shown in FIG. 5 and the operation section 210 shown in FIG. 6.

A communication device 1024 exchanges information utilized in the instrument with the outside. The communication device 1024 is connected with another device through a communication channel and is utilized to transmit and receive given information corresponding to a program or the like. The communication device 1024 corresponds to the communication section 130 shown in FIG. 5 and the communication section 230 shown in FIG. 6.

### 5. Effects

According to this embodiment, the pieces of character control data 171 are selected according to the distribution pattern indicated by the game terminal 20 based on the experience level and the used character received from the game terminal 20, and 100 pieces of selected character control data 171 are collectively downloaded to the game terminal 20 as the package data.

Since 100 pieces of control data 171 are collectively downloaded as the package data, a number of pieces of control data can be acquired at one time without downloading the pieces of control data one by one. Moreover, since the pieces of character control data 171 are selected based on the experience level received from the game terminal 20, the pieces of control data can be acquired corresponding to the skill of the player.

In more detail, when the player has selected the distribution pattern A, the pieces of character control data 171 are selected according to the Gaussian distribution around the received experience level. Therefore, appropriate pieces of control data can be acquired when the player desires to play a match with control characters over a wide level range collected in a well-balanced manner.

When the player has selected the distribution pattern B, a large number of pieces of character control data 171 with an experience level higher than the received experience level are selected. Therefore, appropriate pieces of control data can be acquired when the player desires to play a match with a number of control characters with a level higher than the player's level rather than control characters with a level lower than the player's level.

When the player has selected the distribution pattern C, only the pieces of character control data 171 with the received experience level or an experience level close to the received experience level are selected. Therefore, appropriate pieces of control data can be acquired when the player desires to play a match with uniformly collected control characters with a level almost the same as the player's level.

### 6. Modification

### 6-1. System Configuration

This embodiment has been described above taking an example in which the game server 10 executes the data management process. Note that a game system may be created by connecting the game terminals 20 so that one of the game terminals 20 realizes the function of the game server 10. Specifically, although this embodiment has been described above taking the configuration (A) of the configurations (A) to (D) of the game system utilizing a network game as an example, the game system may have the configuration (C), for example.

### 6-2. Game terminal

The game terminal 20 is not limited to a consumer game machine. The game terminal 20 may be a portable game machine, an arcade game machine, or a personal computer (PC) installed in each home.

### 6-3. Application of Other Games

This embodiment has been described above taking an example in which the player plays a fighting game as the unit game utilizing the game terminal 20. Note that the game to which the invention can be applied is not limited thereto. For example, the invention can also be applied to a puzzle game, a quiz game, a racing game, a music game, and the like. When applying the invention to a puzzle game or a quiz game, a number of pieces of question data may be downloaded as the package data.

A case of applying the invention to a racing game or a music game is described below.

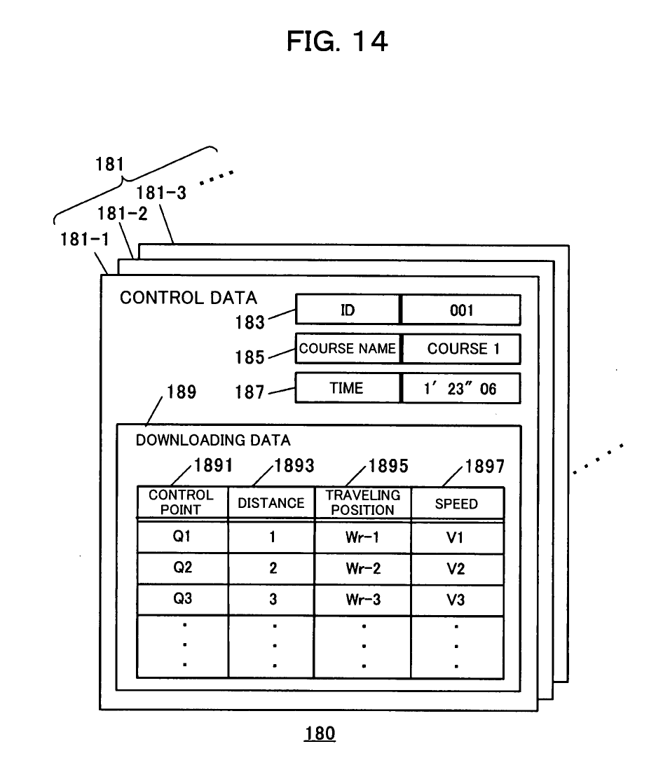

FIG. 14 is a view showing a data configuration example of a control DB 180 stored in the game server 10 when applying the invention to a motorcycle racing game which is one type of racing game.

The control DB 180 stores a number of pieces of control data 181 (181-1, 181-2, 181-3, . . . ) for controlling motorcycles (hereinafter called “rival machines”) which compete with a motorcycle operated by the player. An ID 183, a course name 185 indicating the name of a course where a race is carried out, a finish time 187, and downloading data 189 are stored as the control data 181.

In the downloading data 189, a control point 1891 provided on the center line of the course at specific intervals, a distance 1893 which is the distance from the start position to the control point, a traveling position 1895 which is the distance between the actual traveling line of the motorcycle at the control point and the center line of the course, and a speed 1897 which is the traveling speed of the motorcycle at the control point are associated with one another. Each rival machine is controlled by a CPU based on the downloading data 189.

In this case, the pieces of control data 181 which are downloaded to the game terminal 20 as the package data are determined based the time 187 instead of the experience level. In more detail, the game server 10 receives the time included in the play data from the game terminal 20, and selects the pieces of control data 181 according to the same procedure as described above using the distribution pattern shown in FIG. 3A to 3C in which the horizontal axis indicates the time instead of the experience level.

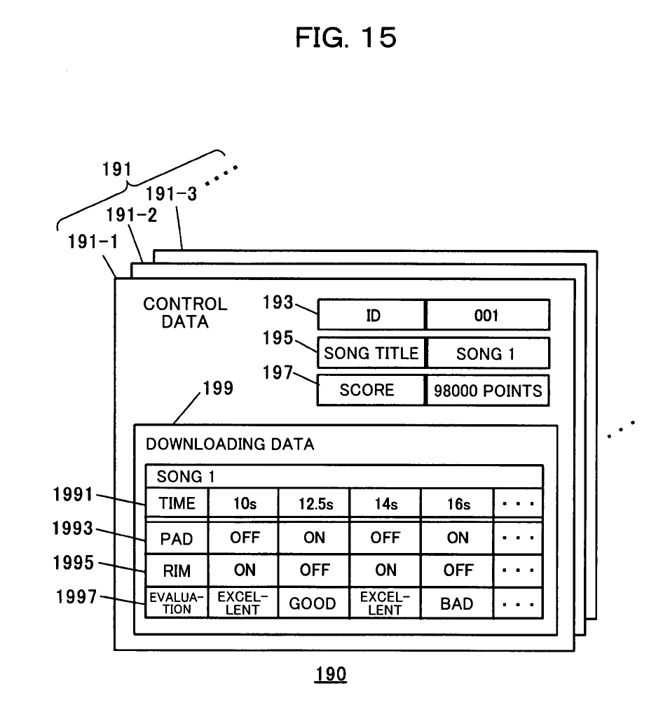

FIG. 15 is a view showing a data configuration example of a control DB 190 stored in the game server 10 when applying the invention to a Japanese drum playing game which is one type of music game.

The control DB 190 stores a number of pieces of control data 191 (191-1, 191-2, 191-3, . . . ) for controlling the operations of characters (hereinafter called “rival characters”) which compete with the player. An ID 193, a song title 195 indicating a performance target song title, a score 197 indicating a score at completion of performance, and downloading data 199 are stored as the control data 191.

In the downloading data 199, a time 1911 indicating the time at which the beat target portion of the Japanese drum is beaten, a pad 1913, a rim 1915, and an evaluation 1917 are associated with one another. The pad 1913 and the rim 1915 are flags indicating whether or not the pad and the rim of the beat target portion have been beaten. The flag is set to “ON” when the pad or the rim has been beaten, and set to “OFF” when the pad or the rim has not been beaten. The evaluation 1917 indicates the evaluation of the beat timing. “Excellent”, “good”, “”fair”, or “bad” is set as the evaluation 1917. The rival character is controlled by a CPU based on the downloading data 199.

In this case, the pieces of control data 191 which are download to the game terminal 20 as the package data are determined based the score 197 instead of the experience level. In more detail, the game server 10 receives the score included in the play data from the game terminal 20, and selects the pieces of control data 191 according to the same procedure as described above using the distribution pattern shown in FIG. 3A to 3C in which the horizontal axis indicates the score instead of the experience level.

### 6-4. Generation of Package Data

This embodiment has been described above taking an example in which the game server 10 executes the package generation process to generate the package data in response to the request from the game terminal 20. Note that the package data may be generated in advance.

In more detail, the package data is generated in advance for all of the experience levels and the used characters according to the package generation process described with reference to FIG. 9. When the game terminal 20 has issued the package data downloading request, the package data corresponding to the experience level and the used character received from the game terminal 20 is selected from the package data generated in advance, and is downloaded to the game terminal 20.

Specifically, since the package data to be downloaded to the game terminal 20 is provided in advance for all of the experience levels and the used characters, the processing load is reduced in comparison with the case of generating the pieces of package data one by one in response to the request from the game terminal 20.

### 6-5. Downloading Method

This embodiment has been described above taking an example in which the pieces of character control data 171 selected from the character control DB 170 are collectively downloaded to the game terminal 20 at one time as the package data. Note that the selected pieces of character control data 171 may be continuously downloaded to the game terminal 20 one by one.

### 6-6. Distribution Pattern

This embodiment has been described above taking the three distribution patterns A to C shown in FIG. 3A to 3C as examples of the distribution pattern. Note that the distribution pattern is not limited thereto. For example, a distribution pattern may be used in which the sum of the numbers specified for the experience levels higher than the standard level is smaller than the sum of the numbers specified for the experience levels lower than the standard level, or a delta-function type distribution pattern may be used in which only the number specified for one experience level is increased to a large extent.

The former distribution pattern is a distribution suitable for the case where the player desires to play a match with a number of control characters with a level lower than the player's level rather than control characters with a level higher than the player's level, and the latter distribution pattern is a distribution suitable for the case where the player desires to play a match with only control characters with a specific level.

### 6-7. Selection Probability of Character Control Data

This embodiment has been described above taking an example in which the pieces of character control data 171 of which the compatibility rank 1793 with the used character 2821 received from the game terminal 20 is “strong”, “rather strong”, “average”, “rather weak”, and “weak” are respectively selected with a probability of “ 1/10”, “ 2/10”, “ 4/10”, “ 2/10”, and “ 1/10”. Note that the selection probability can be arbitrarily changed. For example, the selection probability of “strong” is set at a high value so that a large number of pieces of character control data 171 of which the compatibility rank 1793 is “strong” are selected. Or, the selection probability of “weak” is set at a high value so that a large number of pieces of character control data 171 of which the compatibility rank 1793 is “weak” are selected.

The selection probability may be determined by the player. In more detail, the player inputs the selection probability of each compatibility rank 1793 using the game terminal 20, and the input selection probability is transmitted to the game server 10.

### 6-8. Number of Pieces of Control Data Downloaded

This embodiment has been described above taking an example in which the number of pieces of character control data 171 downloaded as the package data is “100”. Note that the number of pieces of character control data 171 downloaded as the package data is not limited thereto. For example, the pieces of control data are downloaded in a number which allows a normal player to play for about one hour, although the number varies depending on the type of game. In more detail, the number of pieces of control data downloaded as the package data is more preferably about 5 to 100.

The number of pieces of character control data 171 downloaded may be determined by the player. In more detail, the player inputs the number of pieces of character control data 171 downloaded using the game terminal 20, and the input number is transmitted to the game server 10. The game server 10 selects the pieces of character control data 171 in a number corresponding to the received number, and downloads the selected pieces of character control data 171 to the game terminal 20 as the package data. This allows the pieces of character control data 171 in a number desired by the player to be acquired.

The number of pieces of character control data 171 downloaded may be changed depending on the free space in the storage section 260 of the game terminal 20. In more detail, the game terminal 20 calculates the free space in the memory card 280, and roughly estimates the number of pieces of character control data 171 which can be additionally stored. When the game terminal 20 requests the game server 10 to download the package data, the game terminal 20 transmits the roughly estimated number to the game server 10 in addition to the experience level 2831 and the used character 2821. The game server 10 selects the pieces of character control data 171 in a number corresponding to the received number in response to the request, and downloads the selected pieces of character control data 171 to the game terminal 20 as the package data.

As another configuration, the game terminal 20 may transmit the free space in the memory card 280 to the game server 10, and the game server 10 may select the pieces of character control data 171 so that the received free space is not exceeded. In more detail, the game server 10 selects 100 pieces of character control data 171 according to the procedure described in this embodiment. The game server 10 excludes the selected pieces of character control data 171 in the order from the character control data 171 with a larger size until the total size of the character control data 171 becomes equal to or less than the received free space. The above configuration effectively prevents a situation in which the pieces of character control data 171 are downloaded in a number exceeding the free space in the storage section.

### 6-9. Type of Control Data Downloaded

In this embodiment, since the pieces of character control data 171 downloaded are determined based only on the experience level 2831 and the used character 2821 received from the game terminal 20, the same piece of character control data 171 may be repeatedly downloaded when downloading the package data a number of times. The following configuration may be employed to prevent such a situation.

Specifically, the game server 10 manages the pieces of character control data 171 for each game terminal 20 (or the player who uses the game terminal 20). In more detail, the game server 10 stores and manages the downloaded character control data 171 and the nondownloaded character control data 171 for each game terminal 20 (or the player who uses the game terminal 20) while associating the pieces of character control data 171 with the game terminal 20. The game server 10 receives the identification information (or the player name) of the game terminal 20 from the game terminal 20, selects the nondownloaded character control data 171 from the pieces of character control data 171 stored while being associated with the received identification information (or the player name), and downloads the selected character control data 171.

As another configuration, when the game terminal 20 requests the game server 10 to download the package data, the game terminal 20 transmits an indication signal which excludes the downloaded character control data 171 to the game server 10 in addition to the play data 2831 and the used character 2821. The game server 10 selects the character control data 171 other than the character control data 171 excluded by the received indication signal, and downloads the selected character control data 171.

The type and the number of pieces of character control data 171 downloaded may be designated by the player. For example, the player may designate that 200 pieces of data be randomly downloaded, or may designate that 50 pieces of data with an experience level lower (higher) than the player's experience level be downloaded.

### 6-10. Distribution of Package Data using Medium

A selling configuration in which the package data is stored in a medium such as a CD-ROM and mailed in response to the request from the player may be employed instead of a configuration in which the player downloads the package data from the game server 10.

Although only some embodiments of the invention have been described above in detail, those skilled in the art would readily appreciate that many modifications are possible in the embodiments without materially departing from the novel teachings and advantages of the invention. Accordingly, such modifications are intended to be included within the scope of the invention.

What is claimed is:

1. A server connected via a communication channel with a game device capable of executing a unit game which realizes various game processes using different pieces of control data, the server comprising:
a control data storage section which stores a number of pieces of control data while associating each piece of control data with an experience level;
a level reception section which receives the experience level from the game device;
a selection section which selects a number of pieces of control data downloaded to the game device from the pieces of control data stored in the control data storage section based on a standard experience level which is the experience level received by the level reception section; and
a downloading section which downloads the pieces of control data selected by the selection section to the game device.

2. The server as defined in claim 1, comprising:
a downloading number reception section which receives the number of pieces of control data downloaded from the game device;
wherein the selection section selects the pieces of control data in the number received by the downloading number reception section.

3. The server as defined in claim 1, comprising:
a downloaded data management section which manages the pieces of control data downloaded by the downloading section in units of the game device or a user of the game device as a requester; and
a requester information reception section which receives from the game device requester information which is identification information of the game device or a user name of the game device;
wherein the selection section selects the control data which has not been downloaded to the requester based on the requester information received by the requester information reception section and the control data which has been downloaded to the requester and is managed by the downloaded data management section.

4. The server as defined in claim 1, comprising:
a downloading exclusion data reception section which receives an indication signal indicating a piece of control data excluded from a downloading target from the game device;
wherein the selection section selects the downloading target control data without selecting the piece of control data excluded from the downloading target which is indicated by the indication signal received by the download exclusion data reception section.

5. A server connected via a communication channel with a game device capable of executing a unit game which realizes various game processes using different pieces of control data, the server comprising:
a control data storage section which stores a number of pieces of control data while associating each piece of control data with an experience level;
a selection section which executes a process of selecting a number of pieces of control data downloaded to the game device from the pieces of control data stored in the control data storage section based on a given standard experience level while setting each of the experience levels as the standard experience level;
a level reception section which receives the experience level from the game device; and
a downloading section which downloads the pieces of control data selected by the selection section when setting the experience level received by the level reception section as the standard experience level to the game device.

6. The server as defined in claim 1,
wherein the unit game is a game in which a player's character plays a match with a computer-controlled character which is computer-controlled based on the control data;
wherein the game device includes a control data generation section which generates control data used as a control standard when controlling the player's character of the game device as the computer-controlled character;
wherein the server further includes a control data reception section which receives the control data generated by the control data generation section of the game device from the game device; and
wherein the control data storage section stores the control data received by the control data reception section.

7. The server as defined in claim 5,
wherein the unit game is a game in which a player's character plays a match with a computer-controlled character which is computer-controlled based on the control data;
wherein the game device includes a control data generation section which generates control data used as a control standard when controlling the player's character of the game device as the computer-controlled character;
wherein the server further includes a control data reception section which receives the control data generated by the control data generation section of the game device from the game device; and
wherein the control data storage section stores the control data received by the control data reception section.

8. The server as defined in claim 1,
wherein the selection section selects the pieces of control data with a neighborhood level including the same level as the standard experience level and a level near the standard experience level as the downloading target control data.

9. The server as defined in claim 5,
wherein the selection section selects the pieces of control data with a neighborhood level including the same level as the standard experience level and a level near the standard experience level as the downloading target control data.

10. The server as defined in claim 8,
wherein the selection section selects the pieces of control data with a level other than the neighborhood level in addition to the pieces of control data with the neighborhood level in a number smaller than the number of pieces of control data with the neighborhood level.

11. The server as defined in claim 9,
wherein the selection section selects the pieces of control data with a level other than the neighborhood level in addition to the pieces of control data with the neighborhood level in a number smaller than the number of pieces of control data with the neighborhood level.

12. The server as defined in claim 10,
wherein the selection section selects the pieces of control data with a level other than the neighborhood level so that the number of pieces of control data with a level other than the neighborhood level decreases as the level moves away from the neighborhood level.

13. The server as defined in claim 11,
wherein the selection section selects the pieces of control data with a level other than the neighborhood level so that the number of pieces of control data with a level other than the neighborhood level decreases as the level moves away from the neighborhood level.

14. The server as defined in claim 1,
wherein the selection section selects the pieces of control data with a level higher than the standard experience level in a number larger than the number of pieces of control data with a level lower than the standard experience level.

15. The server as defined in claim 5,
wherein the selection section selects the pieces of control data with a level higher than the standard experience level in a number larger than the number of pieces of control data with a level lower than the standard experience level.

16. A game data downloading method for execution by a server connected via a communication channel with a game device capable of executing a unit game which realizes various game processes using different pieces of control data, the server including a control data storage section which stores a number of pieces of control data while associating each piece of control data with an experience level, the method comprising:
a level reception step of receiving the experience level from the game device;
a selection step of selecting a number of pieces of control data downloaded to the game device from the pieces of control data stored in the control data storage section based on a standard experience level which is the experience level received by the level reception section; and
a downloading step of collectively or continuously downloading the pieces of control data selected in the selection step to the game device.

17. A game data downloading method for execution by a server connected via a communication channel with a game device capable of executing a unit game which realizes various game processes using different pieces of control data, the server including a control data storage section which stores a number of pieces of control data while associating each piece of control data with an experience level, the method comprising:
a selection step of executing a process of selecting a number of pieces of control data downloaded to the game device from the pieces of control data stored in the control data storage section based on a given standard experience level for each case where each of the experience levels is set as the standard experience level;
a level reception step of receiving the experience level from the game device; and
a downloading step of collectively or continuously downloading to the game device the pieces of control data selected in the selection step when setting the experience level received by the level reception section as the standard experience level.

18. A game data downloading method for causing a computer which can be connected with the server as defined in claim 1 via a communication channel to download game data from the server, the method comprising:
a game execution step of executing a unit game which realizes various game processes using different pieces of control data based on the control data;
an experience level change step of changing an experience level of a player depending on results of the game executed in the game execution step; and
a downloading control step of transmitting a present experience level to the server to download the pieces of control data corresponding to the present experience level from the server.

19. A game data downloading method for causing a computer which can be connected with the server as defined in claim 5 via a communication channel to download game data from the server, the method comprising:
a game execution step of executing a unit game which realizes various game processes using different pieces of control data based on the control data;
an experience level change step of changing an experience level of a player depending on results of the game executed in the game execution step; and
a downloading control step of transmitting a present experience level to the server to download the pieces of control data corresponding to the present experience level from the server.

20. A game data downloading method for causing a computer which can be connected with the server as defined in claim 2 via a communication channel to download game data from the server, the method comprising:
a downloading number determination step of determining the number of pieces of control data downloaded based on a free space in a storage section which stores the control data downloaded from the server;
a game execution step of executing a unit game which realizes various game processes using different pieces of control data based on the control data;
an experience level change step of changing an experience level of a player depending on results of the game executed in the game execution step; and
a downloading control step of transmitting a present experience level and the number determined in the downloading number determination step to the server to download the pieces of control data corresponding to the experience level from the server in the determined number.

21. A game data downloading method for causing a computer which can be connected with the server as defined in claim 4 via a communication channel to download game data from the server, the method comprising:
a game execution step of executing a unit game which realizes various game processes using different pieces of control data based on the control data;
an experience level change step of changing an experience level of a player depending on results of the game executed in the game execution step; and
a downloading control step of transmitting an indication signal which excludes the control data stored in a storage section which stores the control data downloaded from the server from a downloading target and a present experience level to download the pieces of control data which correspond to the present experience level and are not stored in the storage section from the server.

22. A computer-readable information storage medium storing a program which causes a server to execute the game data downloading method as defined in claim 16.

23. A computer-readable information storage medium storing a program which causes a server to execute the game data downloading method as defined in claim 17.

24. A computer-readable information storage medium storing a program which causes a computer to execute the game data downloading method as defined in claim 18.

25. A computer-readable information storage medium storing a program which causes a computer to execute the game data downloading method as defined in claim 19.

26. A computer-readable information storage medium storing a program which causes a computer to execute the game data downloading method as defined in claim 20.

27. A computer-readable information storage medium storing a program which causes a computer to execute the game data downloading method as defined in claim 21.
